(19) United States
(12) Patent Application Publication
(10) Pub. No.: US 2015/0353180 A1
(43) Pub. Date: Dec. 10, 2015

(54) PLASMA-LIFT APPARATUS AND METHODS FOR MAKING AND USING SAME

(71) Applicant: Scott A. Strozier, Houston, TX (US)

(72) Inventor: Scott A. Strozier, Houston, TX (US)

(21) Appl. No.: 14/264,022

(22) Filed: Apr. 28, 2014

Related U.S. Application Data
(60) Provisional application No. 61/816,192, filed on Apr. 26, 2013.

(51) Int. Cl. B64B 1/58; B64B 1/06

(52) U.S. Cl. CPC B64B 1/58; B64B 1/06

(57) ABSTRACT

Lighter than air apparatuses include at least one ballast container having an electrically insulated and fire resistant, an envelop containing a gas and a plasma generating and heating assembly, where the containers provide lift by generating a plasma within the envelop. In certain embodiments, the envelop includes an expandable portion.

### RELATED APPLICATION

This application claims the benefit of and prior to U.S. Provisional Patent Application Ser. No. 61/816,192, filed 26 Apr. 2013.

### BACKGROUND OF THE INVENTION

1. Field of the Invention

Embodiments of this invention relate to lighter than air apparatuses and methods for making and using same.

More particularly, embodiments of the present invention relate to lighter than air apparatuses, where the apparatuses including at least one ballast container having an electrically insulated and fire resistant, envelop containing a gas and a plasma generating and heating assembly, where the containers provide lift by generating a plasma within the envelop. In certain embodiments, the envelop includes an expandable portion.

2. Description of the Related Art

The first most common method of flight is how commercial planes and jets work. Here, propellers, jet engines or rockets are used to achieve thrust and propel the plane forward. This propulsion allows air to move across the wings; the wings then lift the plane of the ground. The engines must then continue to propel the plane forward in order to maintain an equilibrium between the lift and drag coefficients. In this method, a large amount of fuel is burned and the planes aerodynamics must offer the least amount of resistance possible to be efficient.

The second and one of the earliest methods of flight achieves lift and then propels the vehicle forward examples include hot air balloons and zeppelins. In a zeppelin hydrogen or helium is used, because they are lighter than air, storing them in a balloon will case the zeppelin to rise and propellers can be used to achieve movement. Because of the slow speed, the zeppelins were replaced by airplanes.

Before zeppelins, hot air balloons were the pinnacle of aviation technology. Hot air balloons, much more basic, work simply by heating air within a balloon. Since air becomes lighter as it is heated, the balloon rises, but is at the mercy of the wind. Used as a novelty more than anything else, the hot air balloons never saw much practical use and were quickly replaced by more efficient forms of aviation. However, because of the balloons impracticality an opportunity for improvement might have been missed.

Jets have been constructed to perform vertical take-off by use of lift fans or directional nozzles. The hot air balloon itself is impractical, but the principle may provide a new way to achieve lift.

Thus, there is still a need in the art for new and unique lift technologies, one of which is disclosed herein.

### SUMMARY OF THE INVENTION

Embodiments of this invention provide apparatuses including an aerodynamic housing including at least one ballast container having an electrically insulated and fire resistant, envelop containing a gas and a plasma generating and heating assembly, where the containers provide lift by generating a plasma within the envelop. The apparatuses also include a control system and a maneuvering system. The present technology is based on lift generated by heating the gas in the envelop by passing electric current through the gas, where the gas absorbs energy from the current to from a heated gas, a super heated gas, or a plasma to provide lift. In certain embodiments, the envelop of the present invention comprises an expandable envelop including a fixed chamber and an expansion chamber, while the plasma generating and heating assembly includes at least one plasma generator in the fixed chamber and no, one or a plurality plasma generators in the expansion chamber. The lift technology is similar to the operation of a plasma cutter. A plasma cutter uses electricity and pressurized gas to produce a plasma having sufficient energy to cut through metal. Another way to look at this technology is to think of the technology a fluorescent bulb working in reverse. A fluorescent bulb operates by sends a high frequency low amperage current through a gas simulating the gas to emit light, while generating little heat. The plasma generating and heating assembly of this invention operate in reverse using high amperage currents through a pressurized gas to heat the gas with little light generation.

### BRIEF DESCRIPTION OF THE DRAWINGS

The invention can be better understood with reference to the following detailed description together with the appended illustrative drawings in which like elements are numbered the same:

FIGS. 1A & B depict two view of an embodiment of a gas filled ballast container capable of generating lift when activated.

FIGS. 2A & B depict an embodiment of an apparatus using ballast containers of FIGS. 1A & B.

FIGS. 3A-C depicts an embodiment of an apparatus using an expandable envelop of this invention showing the expansion of the expandable chamber of the envelop.

FIG. 4A-C depicts another embodiment of an apparatus using an expandable envelop of this invention showing the expansion of the expandable chamber of the envelop.

### DETAILED DESCRIPTION OF THE INVENTION

The inventor has found that apparatuses and methods may be constructed to generate lift using ballast containers, where the containers include an insulating and flame resistant envelop including a gas and an electrical unit for passing an electric current though the gas in the envelop to form a heated gas, a superheated gas or a plasma. The ballasts are air tight, in order to prevent any gas from escaping, and contain a pressurized gas or a pressurized gas mixtures. The ballasts are divided into sections or cells, each section or cell includes the pressurized gas, a negatively charged electrode or anode and a positively charged electrode or cathode.

When an electric current passes between the electrodes through the gas, a powerful spark is generated in the pressurized gas in each section. The discharge heats the pressurized gas to form a heated gas, a superheated gas, and/or a plasma. The discharge may be controlled to yield a heated gas, a superheated gas, and/or a plasma having a controllable density, generally a density less than the density of the atmosphere surrounding the ballasts. Generation of the plasma causes the ballasts to give off a large amount of heat. The now superheated air within the ballasts weigh less than the cooler air surrounding the plane. With all sections in the ballast now containing superheated air the ballasts will now lift the plane that they are built around. Lift achieved a propeller or jet engine can now propel the plane forward and even hover in place when necessary. When the plane needs to descend the electric current needs only to be cut off and as the air within the ballast cools the plane will descend. In certain embodiments, the containers may be expandable so that the volume of heated gas, superheated gas, and/or plasma may be increased to increase lift. The expandability may be inherent in the properties of the envelop material or the expandability may be mechanical designed to open closed sections in the containers.

### Suitable Reagents and Equipment Used in the Invention

Suitable gases for use in the present invention include, without limitation, oxygen, nitrogen, air, helium, neon, argon, xenon, krypton, hydrogen, methane, ethane, propane, butane, ethylene, propylene, butene, carbontetrafluoride (CF₄), di, tri, and tetra fluoroethylene, ammonia, freons such as R-12 and R-22, fluorochlorocarbons, hydrogen, methylether, chlorine, bromine, and mixtures or combinations thereof. Liquids may also be used with or without gases. Suitable liquids include, without limitation, water, hydrocarbons, chlorinated hydrocarbons, fluorinated hydrocarbons, ethers, esters, acetates, and mixtures or combinations thereof. Gases and mixtures of gases and liquids may be used. Gas or gas/liquid compositions used in the ballast containers may be a single component, but will generally be a mixture of gases or a mixture of gases and liquids that have optimal properties for converting current into heat. In some embodiments, the gas compositions or gas-liquid compositions may be varied to augment lift during flight. Metals may also be used such as mercury, lithium, sodium, potassium, other metals that form vapors under the application of a current. Of course, the container may be filled with a mixture of gases, liquids or solids. In other embodiments, the gas mixtures includes inert gas such as nitrogen, helium, neon, argon, xenon, carbon dioxide, or mixture and combinations thereof. In other embodiments, the gas-liquid mixture includes an inert gas or mixture thereof and water.

Suitable insulating and flame retardant materials include, without limitation, composites, metals, metallized plastics, rubbers, metallized rubbers, or any other light weight structural insulating and non-flammable materials. Other suitable envelop materials include material used in blimp envelops, or other materials that have low gas permeability and are light weight and durable.

Suitable pressures for use in the containers of this invention include, without limitation, pressures between atmospheric to 100 psi. Of course, as the gas, gas mixture or gas-liquid mixture is heated, the pressure will increase so the starting pressure of the gas, gas mixture, gas-liquid mixture, gas-solid mixture, or gas-liquid-solid mixture is sufficient low that upon heating the final pressure remains at least 10% below the maximum pressure the envelop can withstand.

Suitable temperatures for use in the containers of this invention include, without limitation, temperatures from room temperature to a temperature at least 10% below a decomposition or flammability temperature of the envelop material.

Suitable voltages and currents for use in the containers of this invention include, without limitation, any voltage and current sufficient to achieve the desired degree of heating within the envelop. The voltage may range from 50V to 1 MV, while the current may range from 15 A to 100 A. Of course, the exact voltage and current will be design parameters for a given application. While DC plasma generations is shown in the Figures below, it should be recognized that AC current and inverted current analogs may also be used.

### Detailed Description of the Drawings

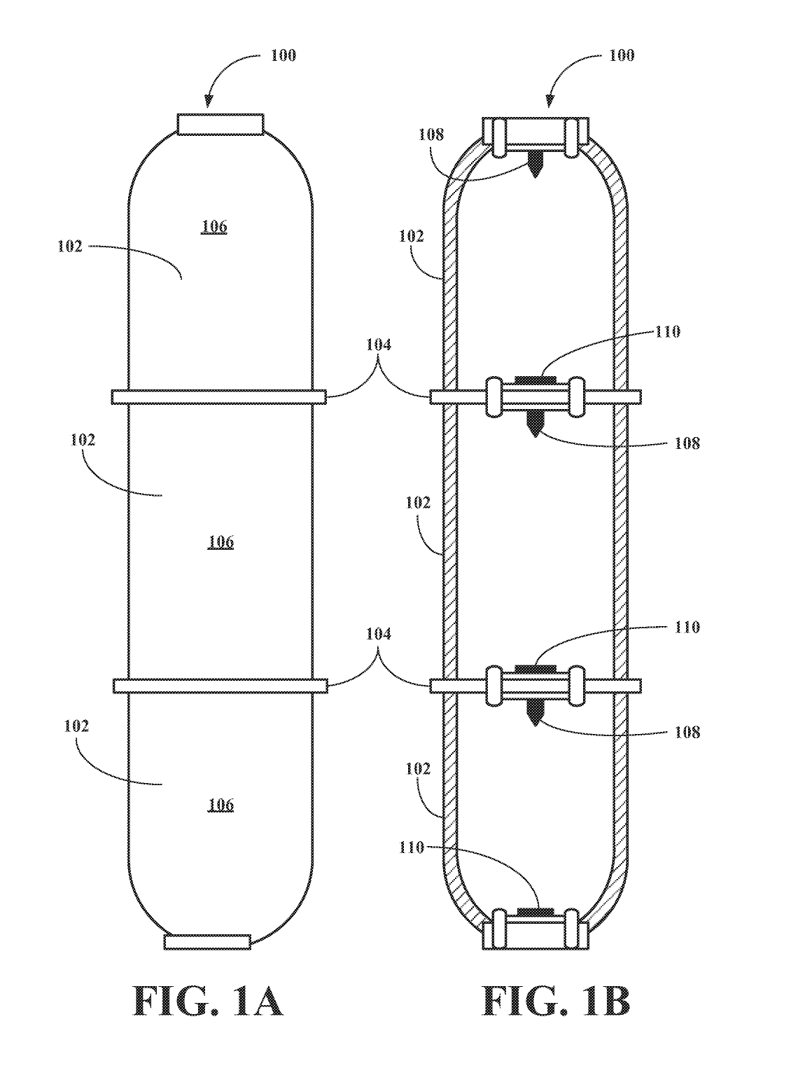

Referring now to FIGS. 1A, an embodiment of a gas filled ballast container, generally 100, is shown to include an insulating and fire resistant envelop 102 and a support frames 104. The frames 104 separate the ballast 100 into sections 106.

Referring now to FIGS. 1B, a cutaway of the envelop 102, where each section 106 is divided by the frames or section links 104. Each section 106 includes a negatively charged electrode or anode 108 opposite a positively charged cathode 110. Here the envelop 102 encloses the pressurized gas that superheats when a current runs through the gas between the anode 108 and the cathode 110.

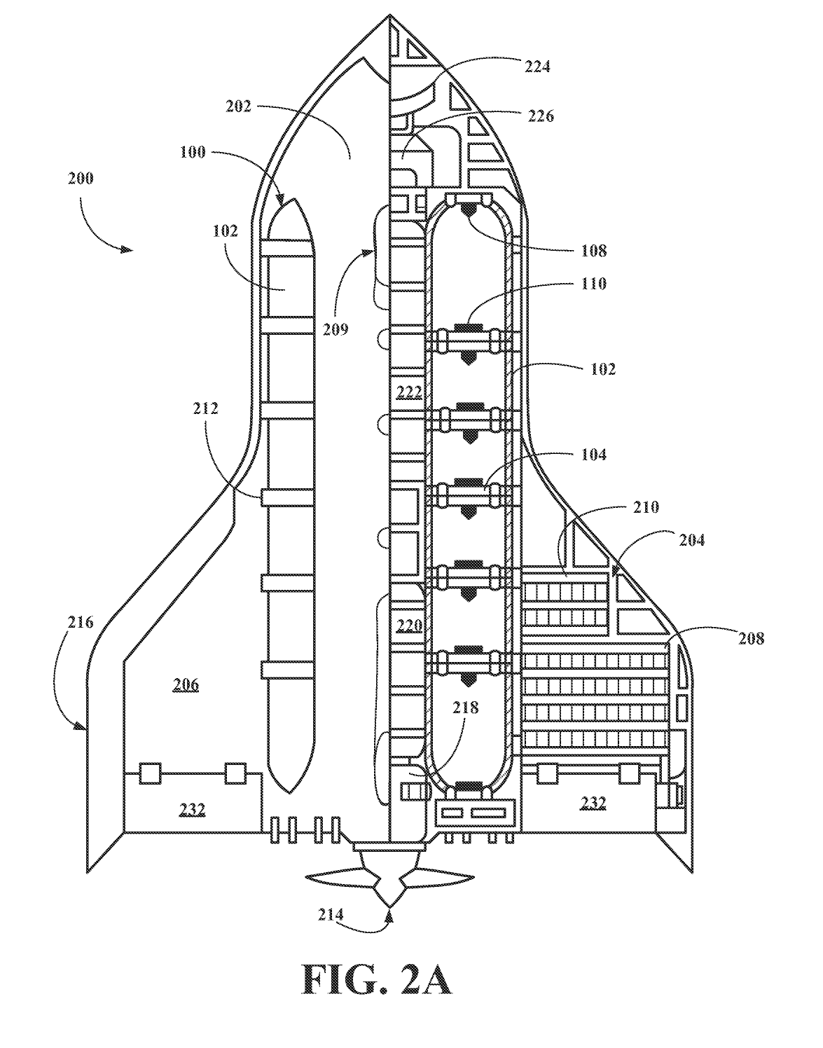

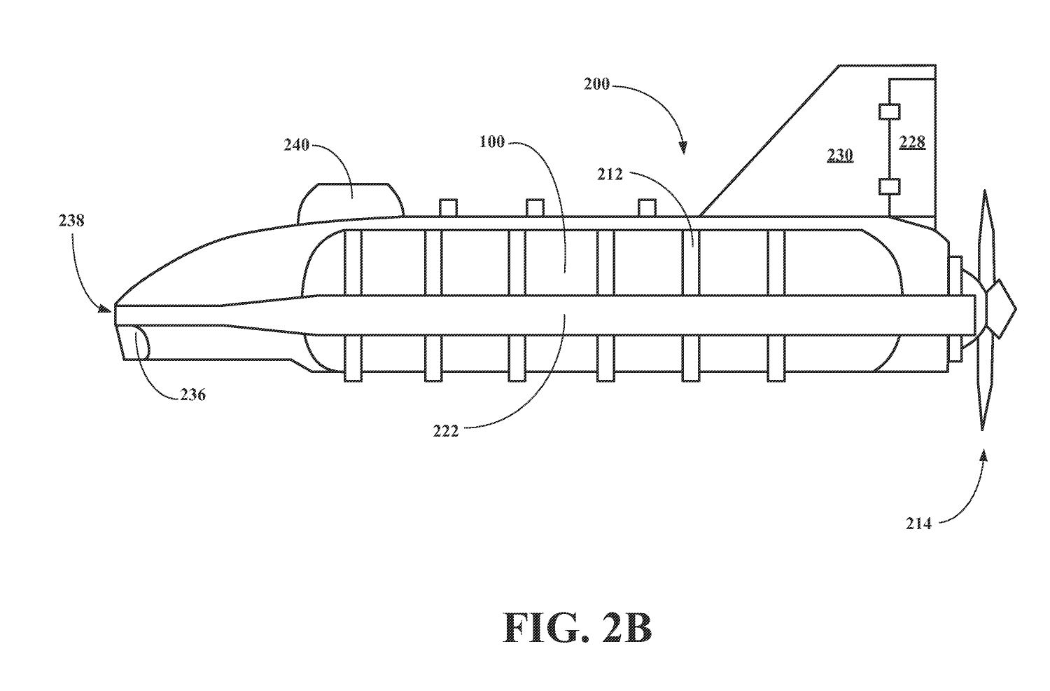

Referring now to FIGS. 2 & B, an embodiment of a lighter than air apparatus or plane of this invention, generally 200, is shown to include two ballasts 100, in a side-by-side configuration. While the apparatus shown here is in the form of a plane, the apparatus 200 may take on any desirable form such as circular, toroidal, elliptical, square, rectangular, cylindrical, etc., and the ballast configuration may be internal or external. The plane 200 is constructed or coated with a heat resistant material 202 to protect the interior equipment of the plane 200. In this design, the ballast tanks 100 are connected to a battery unit 204 in wings 206 of the plane 200 via wires 209. The battery unit 204 also includes batteries 208 and backup batteries 210 in case of emergencies or primary battery failure. The battery unit 204 supplies power to the electrodes 108 and 110 to heat and/or superheat the gas in the ballasts 100. The ballasts 100 are configured in the plane 200 to provide lift. The ballasts 100 are connected to the plane 200 by heat resistant support bars 212. The rest of the plane 200 works the same as a normal plane or unmanned aerial vehicle (UAV) and is propelled forward by a propeller 214 in a rear section 216 of the plane 200. The plane 200 also includes a motor 218 and fuel tank 220 to give it its power along with an auxiliary fuel tank 222 like a normal UAV.

Since this design is a UAV, it is operated remotely by means of an internal satellites communication antenna 224 and its internal navigation system 226. The plane 200 is then steered by a rudder 228 associated with a tail 230 and starboard and port tail fins 232 in order to steer the plane 200. Other than the added ballast tanks 100 of the UAV 200, the plane 200 is heat resistant and the fuel tanks 220 and 222 are protected against the superheated gas in the ballasts 100. This ensures the power unit 204 and forward propulsion system remains undamaged as well as the protection of the avionics equipment 224 and 226.

The plane 200 is steered by means of the rudder 228 and may be used as a surveillance drone by means of an imaging Gimball 236 in a nose 238 of the plane 200 and a GPS antenna 240.

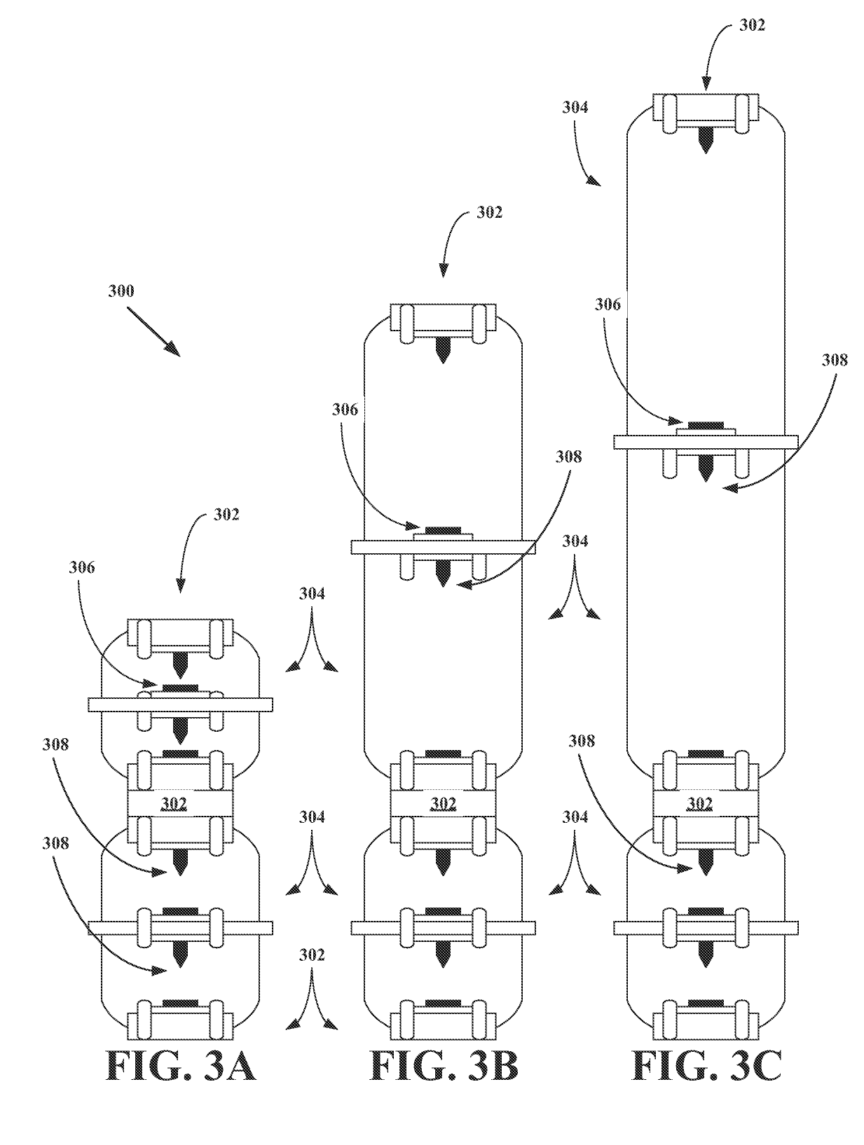

Referring now to FIGS. 3A-C, an embodiment of an expandable envelop generally 300, is shown to include a fixed chamber 302 and an expandable chamber 304. The fixed chamber 302 includes a negatively charged electrode or anode 306 opposite a positively charged cathode 308. The fixed chamber encloses a gas that is superheated when a current runs through the gas between the anode 306 and the cathode 308. As the gas is heated, the gas expands into the expansion chamber 304 providing lift for the apparatus. In this embodiment, the expansion chamber 304 comprises a collapsible resilient material that expands with increasing gas pressure and decreases with decreasing gas pressures. Thus, when the apparatus is not operating, the expansion chamber 304 collapses the gas back into the fixed chamber 302. Once the plasma generators are activated, the heated gas expands the collapsed envelop providing lift, where the amount of lift is controlled by the pressure of the gas.

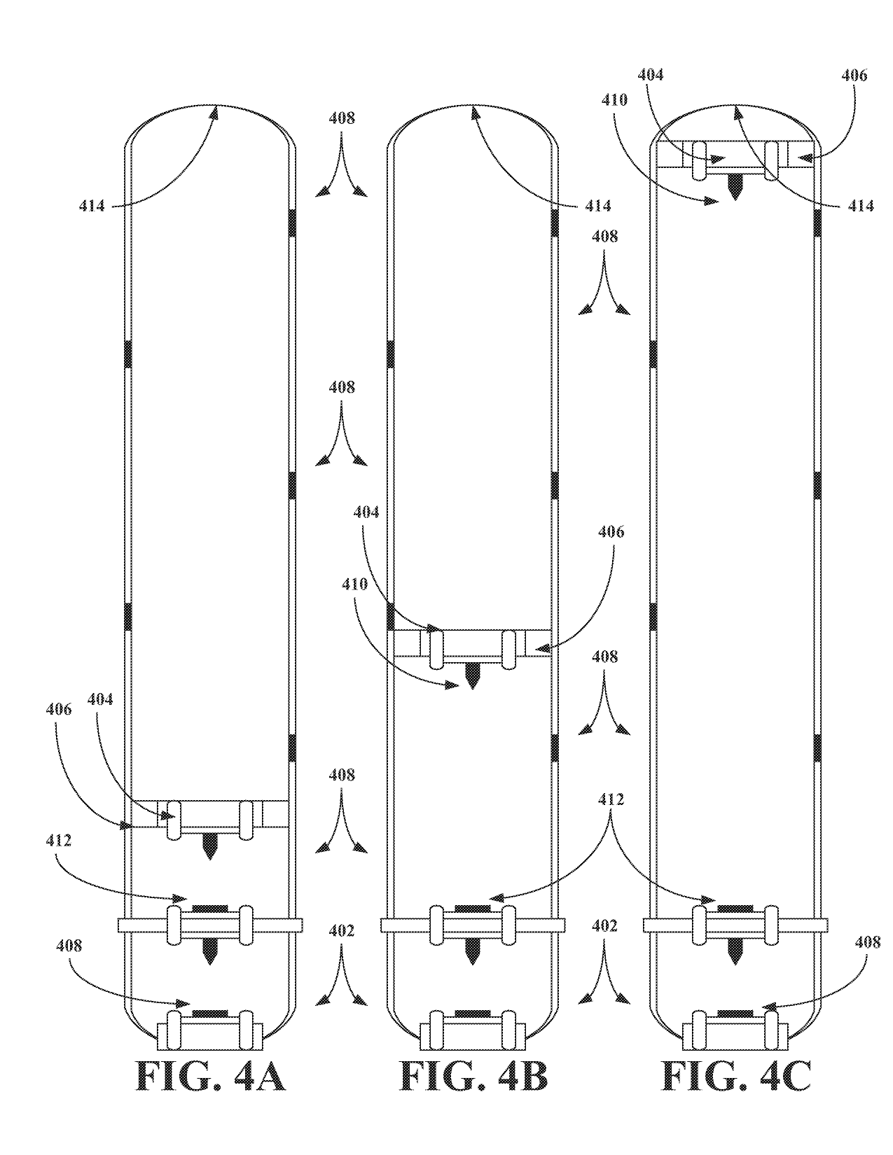

Referring now to FIGS. 4A-C, an embodiment of an expandable envelop generally 400, is shown to include a fixed chamber 402 and a piston actuated expandable assembly 404 including a piston 406 movable within a rigid expansion chamber 408. The fixed chamber 402 includes spaced apart negatively charged electrodes or anodes 410 opposite spaced apart positively charged electrodes or cathodes 412. The fixed chamber 402 encloses a gas that is superheated when a current runs through the gas between the anodes 412 and the cathodes 410. As the gas is heated, the gas expands and moves the piston 406 toward an end 414 of the rigid expansion chamber 408. As the gas expands and the piston moves, lift is provided for the apparatus. Thus, when the apparatus is not operating, the piston 406 resides in its low pressure state abutting the fixed chamber 402. Once the plasma generators are activated, the heated gas expands moves the piston 406 along the rigid expansion chamber 408 providing lift, where the amount of lift is controlled by the pressure of the gas and the position of the piston 406 in the chamber 404.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. An apparatus comprising:
an aerodynamic housing including:
at least one ballast container having:
an electrically insulated and fire resistant envelop including:
a gas, a gas mixture, a gas-liquid mixture, a gas-solid mixture or a gas-liquid-solid mixture, and
a plasma generating and heating assembly,
where the containers provide lift by generating a heated gas, a superheated gas, or a plasma within the envelop.

2. The apparatus of claim 1, further comprising:
a control system and
a maneuvering system.

3. The apparatus of claim 1, wherein the plasma generating and heating assembly heats the gas in the container by passing electric current through the gas, where the gas absorbs energy from the current to form the heated gas, the super heated gas, or the plasma.

4. The apparatus of claim 1, wherein the plasma generating and heating assembly includes at least one anode and cathode.

5. The apparatus of claim 1, wherein the envelop includes a plurality of sections, each section includes a plasma generating and heating assembly.

6. The apparatus of claim 1, wherein the gas is pressurized to a given pressure.

7. The apparatus of claim 1, wherein the gas is pressurized to a given pressure by a pressurization assembly.

8. The apparatus of claim 1, wherein the pressurization system includes a gas source, a dual directional pump, a pressure sensor, and a pump controller, where the controller is adapted to adjust the pressure in the envelop.

9. The apparatus of claim 1, wherein the envelop is expandable.

10. A ballast container comprising:
an electrically insulated and fire resistant envelop including:
a gas, a gas mixture, a gas-liquid mixture, a gas-solid mixture or a gas-liquid-solid mixture, and
a plasma generating and heating assembly,
where the containers provide lift by generating a heated gas, a superheated gas, or a plasma within the container

11. The apparatus of claim 10, wherein the envelop is expandable.

12. A method for generating lift comprising:
confining a gas, a gas mixture, a gas-liquid mixture, a gas-solid mixture or a gas-liquid-solid mixture in a container including an electrically insulated and fire resistant envelop and a a plasma generating and heating assembly,
passing a current through the gas, the gas mixture, the gas-liquid mixture, the gas-solid mixture or the gas-liquid-solid mixture at a rate to heat the gas, the gas mixture, the gas-liquid mixture, the gas-solid mixture or the gas-liquid-solid mixture to a desired elevated temperature, where the elevated temperature is sufficient to impart a desired degree of lift.

13. The method of claim 12, further comprising:
adjusting the current, the gas, the gas mixture, the gas-liquid mixture, the gas-solid mixture or the gas-liquid-solid mixture or the gas, the gas mixture, the gas-liquid mixture, the gas-solid mixture or the gas-liquid-solid mixture pressure to adjust the degree of lift.

14. The method of claim 12, further comprising:
maneuvering a vessel including one or more of the container through the air using a propulsion system.

15. The method of claim 12, further comprising:
allowing the gas to expand into an expandable portion of the envelop.
